(19) United States
(12) Patent Application Publication
(10) Pub. No.: US 2008/0079880 A1
(43) Pub. Date: Apr. 3, 2008

(54) Method of manufacturing liquid crystal display device

(75) Inventors: Akihiro Mochizuki, Louisville, CO (US); Masahito Nakayama, Itami (JP)

Correspondence Address: MORRISON & FOERSTER LLP, 1650 TYSONS BOULEVARD, SUITE 400, MCLEAN, VA, 22102, US

(73) Assignee: Nano Loa, Inc., Kanagawa (JP)

(21) Appl. No.: 11/540,512

(22) Filed: Oct. 2, 2006

(51) Int. Cl. G02F 1/13; G02F 1/1333

(52) U.S. Cl. 349/122; 349/187

(57) ABSTRACT

A liquid crystal filling system comprising: a slit coating system, and a controller for precisely controlling the thickness of a liquid crystal layer provided by the slit coating system.

### BACKGROUND OF THE INVENTION

1. Field of the Invention

The present invention relates to manufacturing method and manufacturing machine for liquid crystal display devices, specifically filling method for smectic liquid crystal display devices.

2. Related Background Art

Recent emerging development of liquid crystal display (LCD) devices for TV application is outstanding. This new application of LCDs for TV, at the same time, requires higher display performance than ever used at LCDS. High viscous smectic liquid crystal materials potentially realize high image quality required for TV application. However, due to high viscosity of smectic liquid crystals, filling of liquid crystal to a panel, in particular to a large screen TV panel, has still some critical problems. Although ODF (One Drop Filling) is being used for filling of large screen panels with conventional nematic liquid crystal materials, highly viscous smectic liquid crystal needs innovative filling method to meet with high manufacturing throughput. It is highly required to realize practically effective manufacturing method for smectic liquid crystal materials. In particular, inexpensive filling machine without complicated system such as high vacuum and very accurate temperature control is extremely required for high efficient volume manufacturing of smectic base liquid crystal displays. Moreover, without using high temperature such as 100 degrees C., selection of applicable perimeter seal materials has less restriction, resulting in more effective volume manufacturing of smectic base liquid crystal displays.

Technical Problem of Current Manufacturing Method

Conventional Liquid Crystal Filling Method for Manufacturing

Recent rapid development of liquid crystal display technology has enabled to apply large screen TVs. This development has also been applied to large computer monitors such as 15-inch, 17-inch and over 20-inch diagonal screens. This rapid increase of screen size has requested new liquid crystal filling method at volume manufacturing. The conventional liquid crystal filling method that is known as the pressure deference method between vacuum and standard atmosphere (Vacuum method) consumes a lot of excess amount of liquid crystal, in particular for large TV panels. Moreover, the vacuum method takes long time to fill large panels sometimes longer than 12 hours, which makes manufacturing throughput very low.

The ODF method introduced for large panel fillings requires minimum amount of liquid crystal material and much shorter filling time than conventional Vacuum method. Therefore, the ODF method is more popular than ever, in particular for large screen panel filling.

On the other hand, requirement for large panel screen in LCD-TVs needs higher performance liquid crystal display mode than that of widely used TN (Twisted Nematic) LCDs. TN-LCDs have significant limitation in their optical response time and viewing angle those are most required for TV image quality. In order to overcome requirement for TV image quality, several nematic liquid crystal based LCD modes are being developed as well as smectic liquid crystal based LCD modes. Particularly, a smectic liquid crystal display based on ferroelectric liquid crystal mode is expected to be one of the most promising technologies to meet with both fast optical response and wide viewing angle.

However, a smectic liquid crystal has very high viscosity such as wax-like material, it is almost impossible for smectic liquid crystals to apply ODF method. It is highly requested to establish innovative filling method which enables highly viscous smectic liquid crystal materials to fill large screen panels with effective manufacturing throughput. To meet with those demand, a temperature controlled ODF filling system and its related process were proposed by the same inventor. Although this system realizes high throughput manufacturing, required precise temperature control and need of vacuum system makes this system very complicated as well as some restriction of applicable perimeter seal materials in terms of coefficient of thermal expansion (CTE) matching matter with that of liquid crystal materials.

Technical Issue the Invention Solves

Following two liquid crystal filling methods are well known for a large screen panel manufacturing.

(1) Vacuum method

(2) ODF method

The Vacuum method uses a vacuum chamber. A liquid crystal panel and liquid crystal material are set in the vacuum chamber. Air in the liquid crystal panel is sack up, then, the fill hole of the liquid crystal panel is touched with liquid crystal material, resulting in covered by liquid crystal material. After the fill hole is covered by liquid crystal material, the vacuum chamber is purged by dried nitrogen gas or dried air. The purged gas in the chamber pushes liquid crystal into the panel.

The ODF method uses non-laminated glass substrates. One side of the substrates is pre-formed perimeter seal pattern. Precisely measured liquid crystal amount is dropped on the substrate pre-formed perimeter seal pattern. Then, the other substrate is laminated to complete panel fabrication in a vacuum chamber.

It is clear that the ODF method is much more effective than the Vacuum method in terms of volume manufacturing. Because of its liquid crystal dropping method, the ODF method is very effective for low viscous nematic liquid crystal materials. The dropped liquid crystal material on the pre-formed perimeter seal substrate is easily propagated to all over the substrate by the given pressure from laminated the other substrate. On the contrary, high viscous smectic liquid crystal material is not easy to propagate to all over the panel by the lamination pressure due to its high viscosity. Elevated temperature helps to reduce viscosity of smectic liquid crystal materials, and makes uniform propagation to all over the substrate. One of the problems of this temperature increase is volume expansion of materials. At the isotropic temperature such as 100 degrees C., the viscous smectic liquid crystal material at room temperature shows low viscosity. This low viscosity effectively spreads out the liquid crystal material to all over the panel. After the liquid crystal is filled at the high temperature, the liquid crystal material is filled to all over the panel whose volume is expanded by high temperature. Decreasing ambient temperature creates different volume shrinks among perimeter seal, glass substrates, spacer material, and liquid crystal. If the coefficient of thermal expansion (CTE) of the liquid crystal material is the largest, which is usually happened, this volume shrink creates bubble in the panel due to the difference in CTEs. This prohibits for the ODF method to apply large panel filling. Therefore, an effective liquid crystal filling method for viscous smectic liquid crystal materials, which reduces viscosity by temperature increase without making bubble at the decrease of temperature, is highly required for volume manufacturing of smectic liquid crystal display devices. Moreover, elevation of temperature for large panel larger than 30-inch diagonal, needs precise uniformity of temperature. This uniformity of temperature requires temperature control both increase and decrease of temperature control. This is not easy, in particular size of panel is large such as over 30-inch diagonal.

Moreover, both glass transition temperature (Tg) and coefficient of thermal expansion (CTE) of the perimeter seal material are strictly restricted to a certain value to maintain high throughput of the liquid crystal filling process. Due to differences of Tg and CTE between perimeter seal material and smectic liquid crystal, very slow temperature reduction form high temperature to room temperature is required to avoid disturbance of smectic layer formation in the panel. However, slow reduction of temperature takes long time for the liquid crystal filling process. This long time process makes manufacturing throughput of the liquid crystal filling process longer than acceptable rate, resulting in unrealistic product numbers and product cost. Therefore, to get rid of this long time temperature reduction under the precise temperature control is most necessary to provide high product throughput of the large sized liquid crystal panel. This requirement is specifically important for high viscous liquid crystal material at room temperature such as smectic liquid crystal materials, however, the intrinsic requirement is to realize high product throughput for large sized liquid crystal panels. It is clear that above requirement is not limited in smectic liquid crystal materials, but also applied to all of viscous liquid crystal materials at room temperature.

The polarization shielded smectic liquid crystal display, or PSS-LCD which is promising for higher image quality TV application, needs precise temperature control, in particular, temperature decreasing process such as 1 degree per 1 minute in all over the panel. This requests very precise temperature control as well as uniformity to all over the large panel screen. Therefore, avoiding precise temperature control during the liquid crystal filling without providing any air bubble, or excess amount of filled liquid crystal material in a panel is the key issue for high manufacturing throughput.

### SUMMARY OF THE INVENTION

Method to Solve the Technical Issues

The above technical issues are investigated to solve. Two major problems are investigated. One is method to avoid precise temperature control at ODF method; the other is solution to prevent from creation of bubble at the lamination process of the panel.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1: The slit coating liquid crystal filling process

FIG. 2: Specific gap between perimeter seal pattern and coated liquid crystal area

FIG. 3: The perimeter seal pattern before and after lamination

FIG. 4: After lamination of the relationship between perimeter seal pattern and coated liquid crystal area

FIG. 5: The width and height of designed perimeter seal pattern

FIG. 6: Definition of perimeter seal before and after lamination

FIG. 7: 16:9 wide screen area

FIG. 8: The designed perimeter seal pattern with open areas

FIG. 9: The designed perimeter seal pattern with open area after lamination

FIG. 10: Other slit coating liquid crystal filling process

FIG. 11: The coated liquid crystal layer area used this invention

FIG. 12: The perimeter seal pattern after the coated liquid crystal area was formed

FIG. 13. Conventional single panel liquid crystal filling

FIG. 14: Multiple panels liquid crystal filling on a single substrate

FIG. 15: Separated nozzle structure avoiding to coat unnecessary area

### DETAILED DESCRIPTION OF PREFERRED EMBODIMENTS

Hereinbelow, the present invention will be described in detail with reference to the accompanying drawings, as desired. In the following description, “%” and “part(s)” representing a quantitative proportion or ratio are those based on mass, unless otherwise noted specifically.

Avoiding Precise Temperature Control

The inventor filed a patent for uniform temperature controlled smectic liquid crystal materials with practical method (USP: Pub. No. 2006/0044508 A1). Although this method is practically effective, still the inventor considered more effective liquid crystal filling method with higher manufacturing throughput.

The most required reason why high temperature is necessary is due to requirement of lower viscosity to meet with ODE method. However, once temperature is elevated to 100 degrees C., heat dissipation process is needed with small enough volume change among liquid crystal material, perimeter seal material and glass substrates to avoid air bubble creation, or lack of liquid crystal amount at room temperature in the panel. As the inventor filed the patent (USP: Pub. No. 2006/0044508 A1). careful matching of coefficient of thermal expansion (CTE) as well as carefully designed perimeter seal pattern makes practically effective ODF for high viscous smectic liquid crystal filling. However, this careful matching sometimes limits selection of use materials for a panel manufacturing. Because of multiple requirement for above materials such as dispensability and CTE of seal materials, hardening process and Tg of seal materials, purity and CTE of seal materials, and so on makes not easy to find out proper types of perimeter seal materials. In order to have wide variety of materials selection at panel manufacturing, which is required for high efficiency volume manufacturing of LCD panels in general, the Inventor reconsidered more practical, more effective and more economical liquid crystal filling method, which enables high manufacturing throughput at liquid crystal filling process.

Basic Concept of Filling High Viscous Liquid Crystal

In general, smectic liquid crystal material shows high viscosity. Its viscosity is much larger than that of nematic liquid crystal material. Sometimes viscosity of smectic liquid crystal is too high to measure by the standard measurement method called rotational viscosity for nematic liquid crystal materials. The rotational viscosity is usually measured by the E-type visco-meter. This method uses tapered cone plate to measure the rotational viscosity. The tapered cone receives slightly different mechanical resistance due to viscosity of liquid crystal material. The E-type visco-meter detects this mechanical resistance, when the tapered cone rotates in the liquid crystal material. For most of smectic liquid crystal materials, much higher viscosity than that of nematic liquid crystal material gives too much higher mechanical resistance to the tapered cone, resulting in far saturated viscosity. Because, there have been no real volume LCD manufacturing with smectic liquid crystal materials, actual viscosity, in particular rotational viscosity has not been measured. However, this does not mean that viscosity of smectic liquid crystal material shows practically unknown viscosity. Actually, viscosity of smectic liquid crystal materials is so high not capable to measure by industrial standard measuring method.

This is the reason why high temperature is required to have low enough viscosity to meet with known liquid crystal filling method. The inventor considered if the high viscosity of smectic liquid crystal material was provided by entirely new liquid crystal filling method. The new liquid crystal filling process must get rid of high temperature heating to avoid any coefficient of thermal expansion (CTE) matching matter. Therefore, the new method must be carried on at room temperature to avoid restriction of materials selection due to the CTE matching issue.

The viscosity of most of smectic liquid crystal materials is close to viscosity of photo-resist materials for semi-conductor manufacturing. In particular, high viscous photo-resist materials are coated on silicon wafer by so-called a slit coater machine. In general, this process is well organized in control of layer thickness without air bubbles under normal atmosphere. Thus, coating method of smectic liquid crystal filling to a panel at room temperature is investigated as a practically effective manufacturing method. As long as a coating method has good enough uniformity in layer thickness, high viscous liquid crystal material fits for so-called slit coating method. However, unlike semi-conductor manufacturing, the liquid crystal filling requires very precise positions of the coating on the glass substrate to have precise lamination with a counter glass substrate without creating any air bubble, nor lack of liquid crystal materials in the laminated panel under a certain condition of perimeter seal pattern.

First of all, what kind of coating method applicable to this particular purpose was investigated. There are several coating methods for viscous materials. A roll coater is used for relatively low viscous materials with relatively thin layer thickness. A slit coater is used for relatively high viscous materials with relatively thick layer thickness such as over one micron meter. In general a slit coater, or a roll coater is being used to have thin layer of resist materials both for flat panel display manufacturing and semiconductor manufacturing. A typical thickness of coating layer is 1 micro meter to 5 micro meters with 3 to 5% variation in thickness uniformity. Moreover, this uniform layer coating is being in use at volume manufacturing of flat panel displays using so called 6^{th} generation mother glass size with fast enough tact time such as 80 seconds for a 1,200 mm×1,600 mm glass substrate without creating any bubble on the coating layer.

Therefore, for smectic liquid crystal materials, the inventor chose the slit coating method for liquid crystal filling. Further investigation of a slit coater machine by inventors made it clear that a certain type of slit coating system is good enough to have precise positioning of the coating with uniform enough coating thickness over large area such as meeting with so called 8^{th} generation mother glasses. For most of smectic liquid crystal display devices and liquid crystal devices require less than 2 micron meters panel gap. This means required coating thickness by a certain types of slit coating machine should be less than 2 micron. For reflective display panels, in general half of the panel gap of transmissive type device is required. In this case, the coating thickness should be 1 micron meter. Depending on smectic liquid crystal display devices, required tolerance for liquid crystal layer thickness has some variation, however, most cases, following tolerance in layer thickness is required.

(1) In general: 2+/−0.1 micron meter (10%)

(2) Preferably: 2+/−0.05 micron meter (5%)

(3) Most preferably: 2+/−0.03 micron meter (3%)

### Current in use of slit coating system for volume manufacturing for flat panel displays does have good enough layer thickness uniformity as described above such as less than 5% thickness uniformity.

Although recent certain type of slit coating machine system has very accurate and uniform coating layer thickness control, above level of thickness uniformity is sometimes still not easy. However, for some cases, current slit coating technology provides good enough uniformity. Therefore, an additional process is required to compensate some unevenness of the coated liquid crystal layer by a certain types of slit coating machine with necessary base.

Method of Obtaining Precisely Uniform Liquid Crystal Layer Thickness

Unlike photo-resist materials for semi-conductor manufacturing, the prepared layer by a slit coating machine is used as a liquid crystal panel. This means that the liquid crystal panel lamination process still gives rise to one more opportunity to control precise liquid crystal layer thickness. The very basic concept of this invention is following.

(1) Prepare almost uniform thickness liquid crystal layer by a certain types of coating machine

(2) Adjust layer of the liquid crystal layer thickness by specific balance between perimeter seal pattern, area and coating area of the liquid crystal material

(3) Above process is carried on at room temperature in principle

(4) The lamination process is carried on under good enough vacuum condition

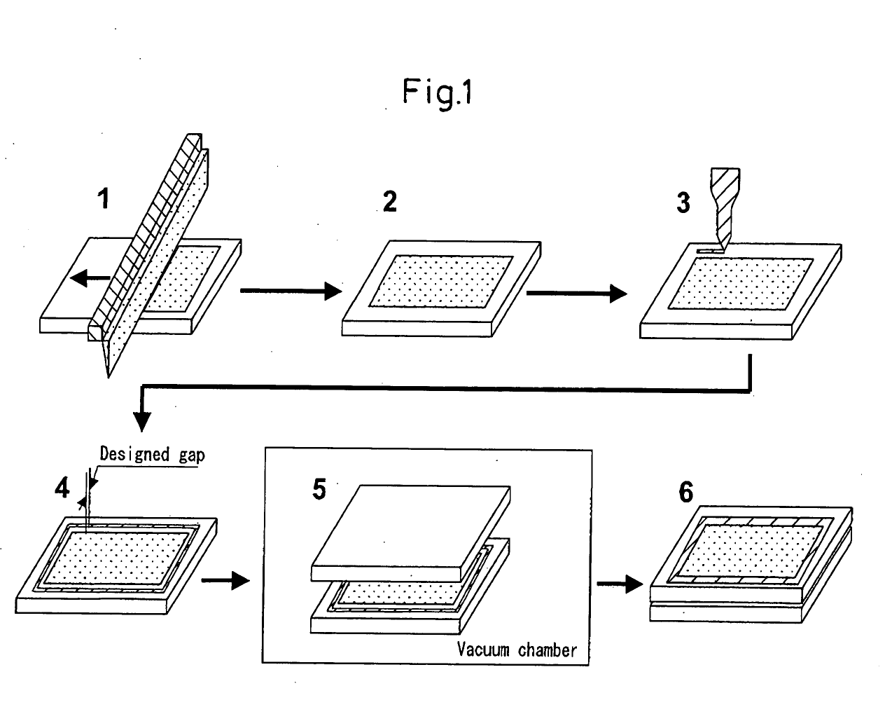

FIG. 1 illustrates the flow of this invention as an actual process. First of all, liquid crystal coating area is decided as a design parameter of the liquid crystal display device. Second, liquid crystal material is coated by a slit coating machine system at the designed area on the one of the glass substrates. Third, based on pre-designed panel gap and perimeter seal height and area, the perimeter seal pattern is dispensed around the coated liquid crystal material. Forth, after the seal glue is dried, the coated glass substrate and other glass substrate for lamination are set in a vacuum chamber. Fifth, after degas process is over, two glass substrates are registered their positioning, and laminated under the vacuum condition. After the perimeter seal is completely dried, the laminated panel is elevated its temperature to set temperature and cooled down to room temperature for initial liquid crystal molecular alignment. In this consecutive process, the first liquid crystal coating process is one of the keys of total process. Depending on required uniformity in the liquid crystal layer thickness, sometimes, as of coated layer thickness is good enough to be used as a liquid crystal display. If the required uniformity of liquid crystal layer thickness, and/or absolute thickness in liquid crystal layer does not satisfy the pre-designed value, consecutive process illustrated in FIG. 1 solves the problem. In general, liquid crystal layer thickness is determined by spacer height built on the surface of the glass substrate, or dispersed on the surface of the glass substrate. For smectic liquid crystal filling, whose viscosity is hard enough to adjust liquid crystal layer thickness depending on spacer height on the glass substrate by known filling method, it is applicable of the spacer height based layer thickness control by introducing new concept described following.

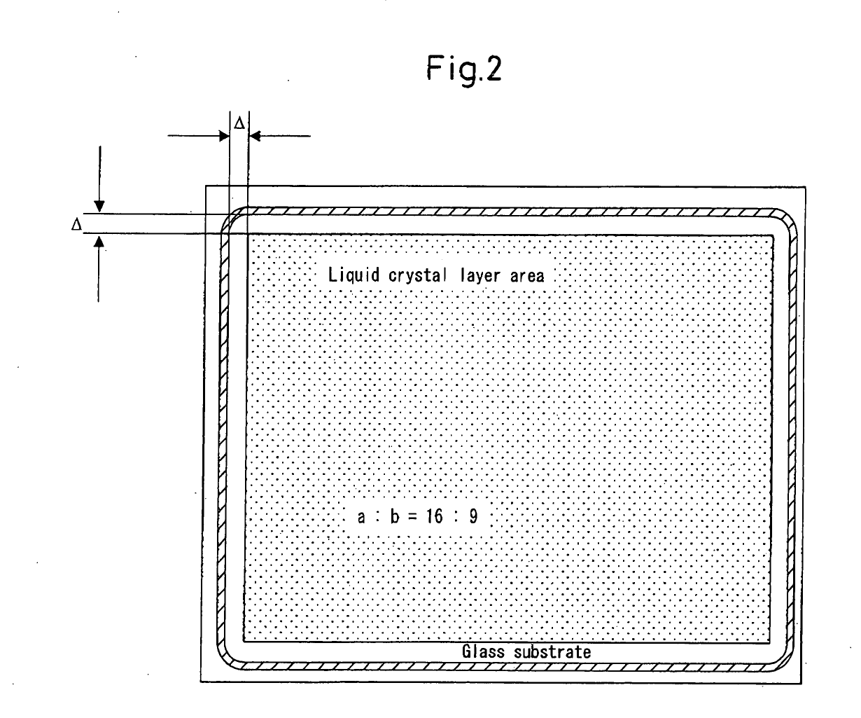

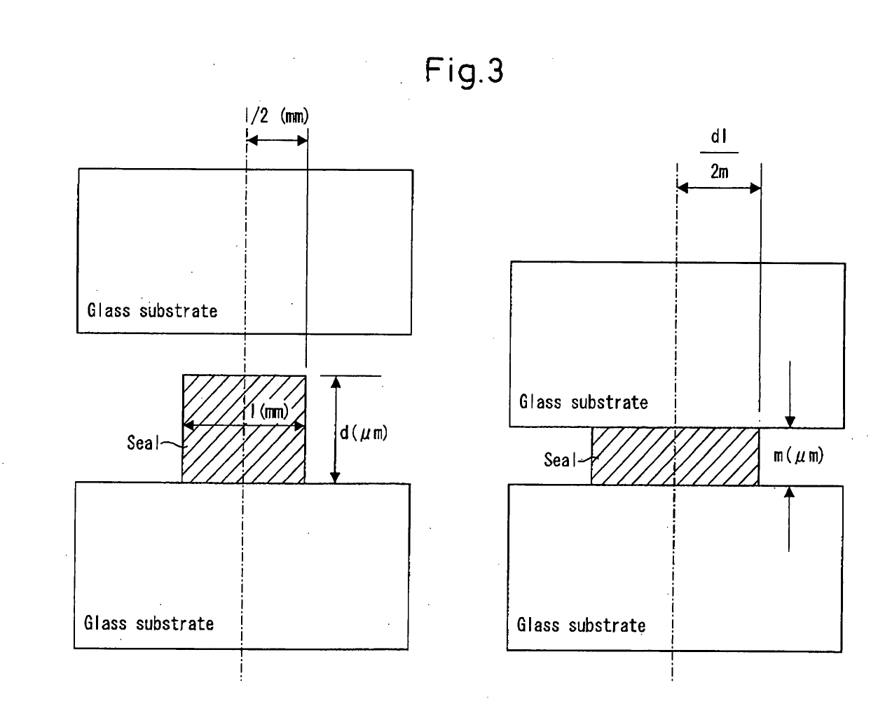

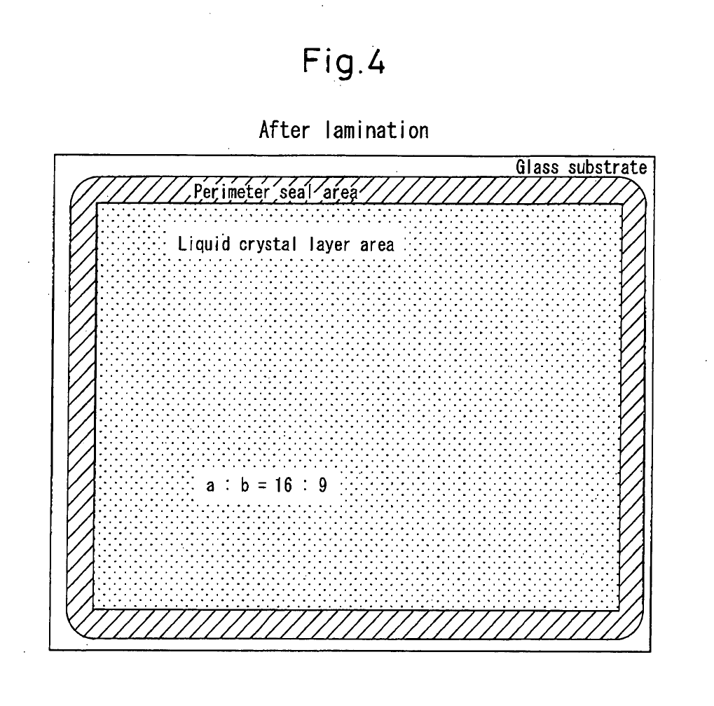

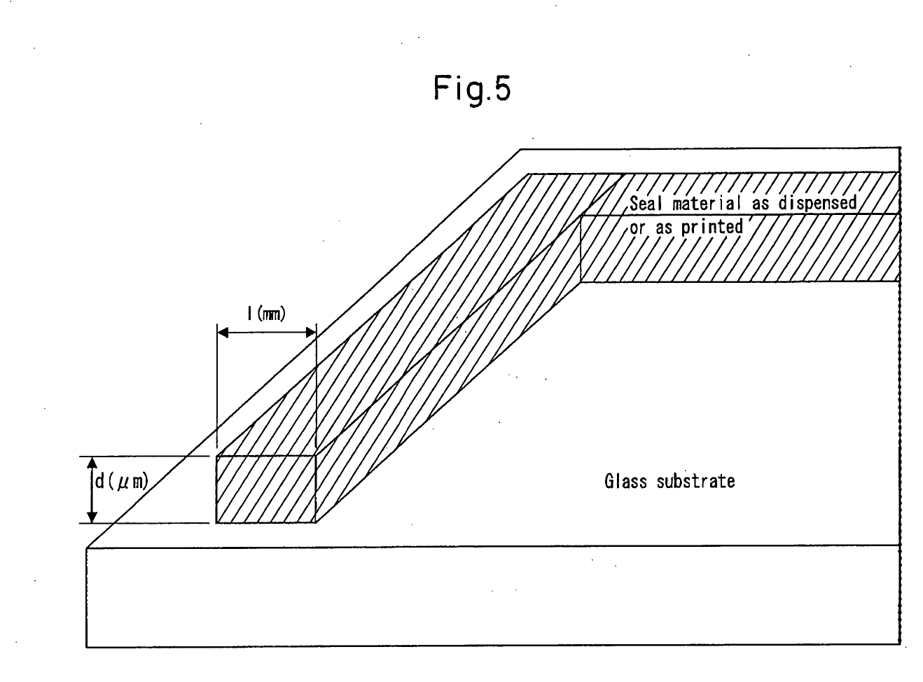

The reason why adjustment of the layer thickness at smectic liquid crystal is difficult, or impossible is simply due to its high viscosity. Due to its high viscosity, lubrication of the smectic liquid crystal material in a panel is too low in general, resulting in difficult, or impossible to adjust layer thickness. The inventor investigated the possible adjustability of the layer thickness of smectic liquid crystal material based on the height of the spacer on the liquid crystal panel. Even though the viscosity of smectic liquid crystal materials is very high compared to that of nematic liquid crystal materials, smectic liquid crystal is still a little bit viscous. It has been tuned out that careful numerical investigation based on a small room of the lubrication of smectic liquid crystal materials enables adjustment of its layer thickness based on the height of spacer on the glass substrate. FIG. 2 shows that precise positioning both of perimeter seal glue and smectic liquid crystal material with precise gap between perimeter seal and smectic liquid crystal materials compensates the set gap by lamination of the two glass substrates with designed panel gap by the height of the spacers on the glass substrate. FIG. 3 shows width of perimeter seal before and FIG. 4 shows width of perimeter seal pattern after lamination. The original seal width l and height d (FIG. 5) change to dl/m, and m, respectively. This perimeter seal width change is caused by pressure of the lamination. This change inside panel, which faces with liquid crystal coating layer, increases the width of perimeter seal dl/2m-l/2. Therefore, the gap between the edge of coated liquid crystal layer and edge of expanded seal line should be set as following equation (1).

Δ=(dl/2m)−(l/2) (1)

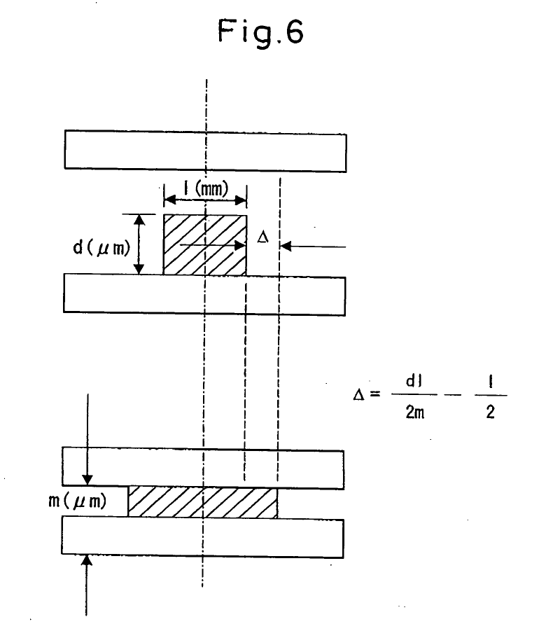

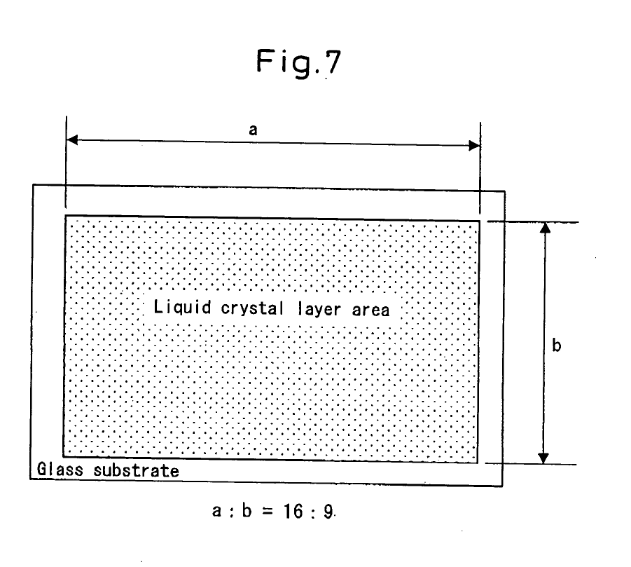

Even more precise layer thickness both in terms of uniformity and absolute thickness is required, the smectic layer thickness or panel gap is adjustable by additional thickness compensation method illustrated in FIG. 6. This type of extremely precise adjustment in terms of above Δ is usually required for relatively small sized displays, or panels with larger ratio of perimeter seal area and liquid crystal area such as less than 15-inch diagonal panels. In general, the ratio between perimeter seal area and liquid crystal layer area has following ratio with 16:9 wide aspect screen cases as shown in FIG. 7.

### Screen Diagonal Size in Inches:

Perimeter Seal Area/Liquid Crystal Layer Area:

| | |
|---|---|
| 50 | 1.5% |
| 40 | 1.9% |
| 30 | 2.5% |
| 20 | 3.7% |
| 15 | 5.0% |
| 10 | 7.5% |
| 5 | 15.1% |
| 2 | 37.6% |

Above ratio is under the premise of same width (3 mm) of perimeter seal regardless screen diagonal size.

As above ratio clearly suggests that screen diagonal size less than 15 inches shows over 5% ratio. The ratio is over 5% may need some other compensation method to avoid lack of liquid crystal materials after lamination, is or to avoid too much excess amount of liquid crystal materials in the panel, resulting in unevenness of panel gap.

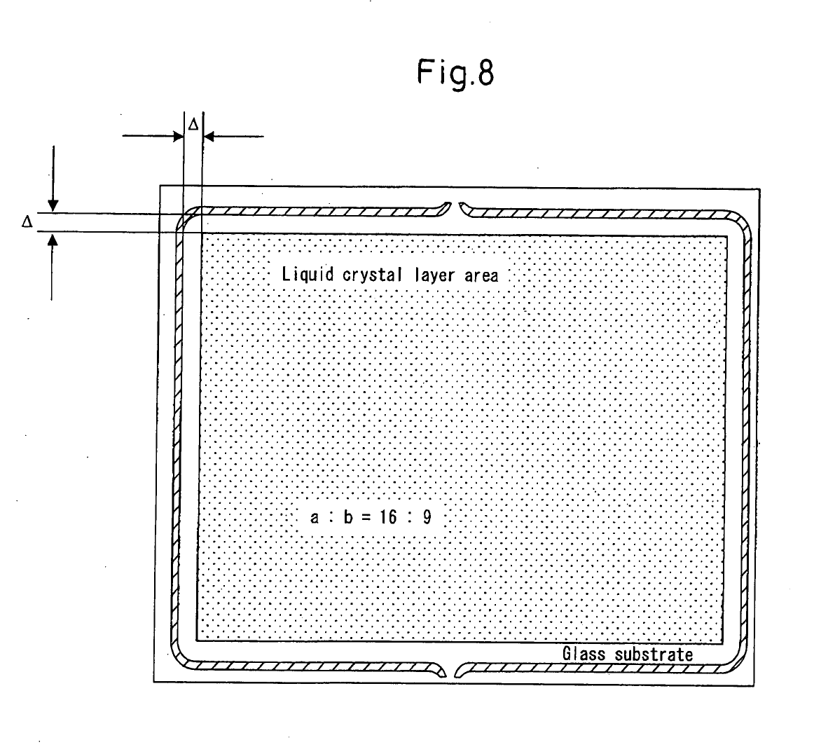

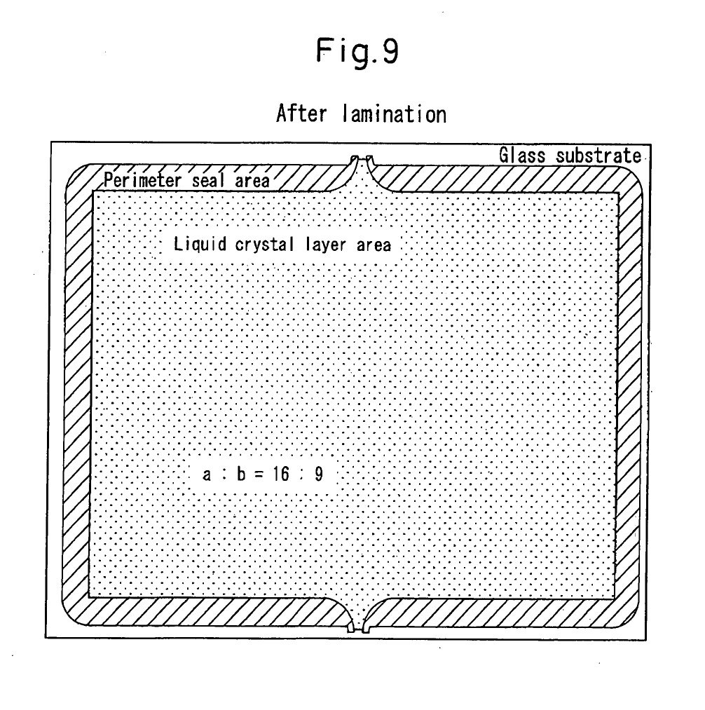

FIG. 8 and FIG. 9 present an additional new concept for smectic liquid crystal layer thickness using the limited lubrication property of the smectic liquid crystal materials. As discussed above, general lubrication of smectic liquid crystal materials is far smaller than that of nematic liquid crystal materials. However, the required adjustment amount by excess amount of smectic liquid crystal materials in the panel is small enough such as several percent in the ratio between perimeter seal area and liquid crystal layer area, and compared to the viscosity of the smectic liquid crystal material, numerical investigation clarified its possibility as mentioned above. Current available slit coating machine provides good enough uniformity in the layer thickness for the viscous materials such as smectic liquid crystal materials, therefore, required amount of adjustment in the smectic liquid crystal layer is small enough as long as the screen diagonal size is over 15 inches diagonal. Less than 15 inches diagonal sized panel would be applicable of conventional temperature controlled filling method. However, larger sized panels such as over 15 inches diagonal screen definitely require much more efficient liquid crystal filling method.

For 42-inch wide screen panel case, current certain slit coating machine enables smectic liquid crystal material coating layer with 2 micro meter+/−0.05 micro meter. Here, suppose that the pre-designed set panel gap is 1.95 micro meter. In this case, maximum of 0.1 micro meter of smectic liquid crystal materials will be excess amount in the 1.95 micro meter panel gap. In all over the 42-inch screen, maximum total amount of 48.64 mm3 of smectic liquid crystal materials must be pushed out from the panel. This excess amount of 48.64 mm3 is 5.13% of the total coated amount on the glass substrate. If faster pushing out of the excess amount of smectic liquid crystal materials is required, slight temperature increase such as 20 degrees over the room temperature is quite effective to accelerate the pushing out. A small increase of ambient temperature such as 20 degrees over the room temperature does not effect significant mismatching in CTEs of related materials as well as not necessary with precise temperature control and temperature uniformity.

This pushing out of the excess amount of smectic liquid crystal materials from the panel needs “drain” system in the panel. In order to have this kind of “drain” system, an open area in the perimeter seal pattern is introduced as illustrated in FIG. 8 and FIG. 9. The open span of the perimeter seal must be carefully designed to keep good enough uniformity of the panel gap as well as effective pushing out of the excess amount of smectic liquid crystal materials with fast enough process. This “open span” design concept is dependent both on total amount of smectic liquid crystal material in the panel and viscosity of the smectic liquid crystal materials. Following is an example of the design concept for the “open span” length. Suppose that 42-inch wide screen panel is filled with smectic liquid crystal materials, and the viscosity of the smectic liquid crystal material is 500 mPa.s. The expected excess amount of the smectic liquid crystal material is 34.05 mm3 (This is 3.6% of the total coated smectic materials on the glass substrate. This amount is estimated from uniformity of initial coating of the liquid crystal layer. Due to some variation of the layer thickness, it is supposed that 70% of the liquid crystal layer has 0.1 micro meter thicker thickness.). In order to push out this excess amount of smectic liquid crystal materials in 5 minutes, the “open span” length should have over 6 mm length at both sides based on our experimental results. If the ambient temperature is elevated to 40 degrees C., the viscosity of smectic liquid crystal materials goes down 25%, then, the “open span” length should be over 4 mm. The 4 to 6 mm length at the perimeter seal is 0.138 to 0.206% of the total length of the perimeter seal pattern. This small open area does not provide any unevenness in panel gap. After the excess amount of liquid crystal materials are pushed out through the open span area by the pressure at lamination, the pushed out liquid crystal material is cleaned off, then the open span area is chipped off by UV curable seal material.

Filling process time of above method is dependent on screen size, viscosity of liquid crystal material, panel gap, and span size of the perimeter seal. Dependent on panel size, process time of this filling process is adjustable by considering span size of the perimeter seal. Because, viscosity of liquid crystal material, and panel gap are pre-set parameter, however, span length of seal pattern is adjustable to the designed throughput of the filling process.

One of the benefits of the coating liquid crystal filling system is its use of wider variety of perimeter seal process. Unlike conventional ODF, or vacuum to atmosphere, or temperature controlled ODF, liquid crystal layer has very small lubrication. Moreover, thanks to this room temperature and at atmosphere process, not only wider section of perimeter seal materials, but also wider selection of their process. Because of high viscous properties of smectic liquid crystal materials, its perimeter seal forming process is applicable with conventional dispensing process, conventional seal printing process, stamping process, and seal taping process just like masking tape process. These wider selections both in perimeter seal materials and their forming process enable the slit coating liquid crystal filling process much more effective both in terms of filling process throughput and quality of the liquid crystal filling.

Other Method of Obtaining Precisely Uniform Liquid Crystal Layer Thickness

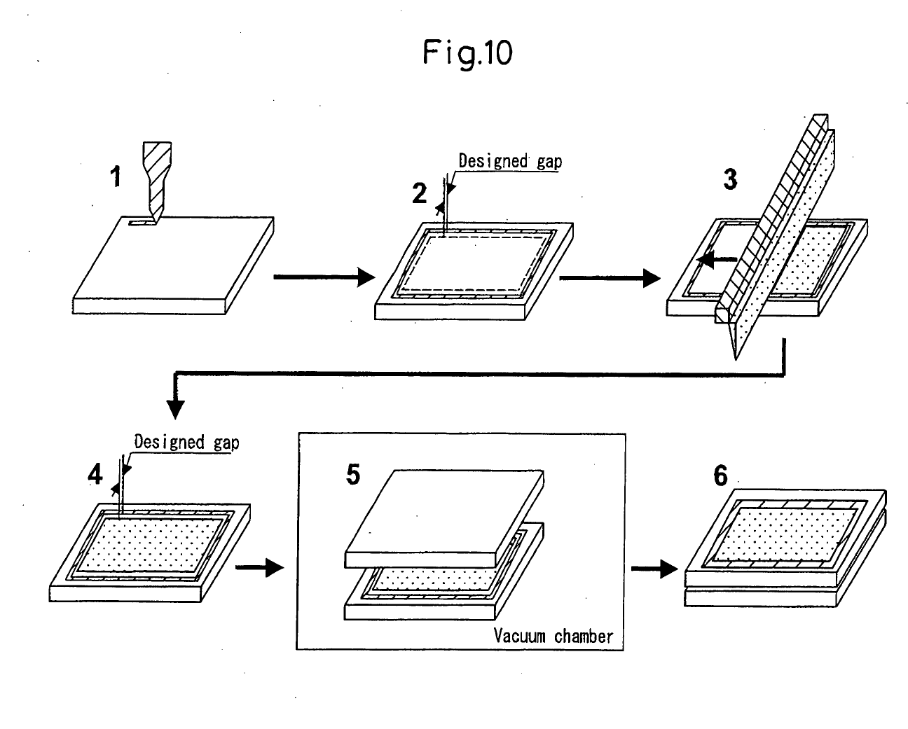

FIG. 10 illustrates other method to obtain precisely uniform liquid crystal layer thickness with fast enough liquid crystal filling time. The difference between FIG. 1 and FIG. 10 is the order of smectic liquid crystal coating and perimeter seal process. In FIG. 10, perimeter seal pattern is made first, then smectic liquid crystal material is coated. This method is suitable for larger sized panel with relatively larger Δ shown in FIG. 2. Perimeter seal pattern is usually formed with higher height of the designed panel gap. For instance, the set panel gap is 2 micro meter, perimeter seal patter as formed before cured is 3 to 3.5 micro meter. A coating of smectic liquid crystal material by a certain type of slit coating machine in the perimeter seal pattern is formed using meniscus performance between the edge of slit coater and glass substrate. Therefore, if the Δ is large enough to form meniscus, perimeter seal pattern is formed before the smectic liquid crystal material is coated on the glass substrate.

Depending on use perimeter seal materials, such as thermosetting, photo-polymerization type, photo-thermo glue, and a green sheet type of tape glue, above two different processes based on the order of seal process and liquid crystal coating process will be chosen to widen selection of perimeter seal materials.

Extended Application of the Same Concept to Other than Smectic Liquid Crystal Materials

As discussed above, the basic concept of this invention is to use nature of high viscosity of liquid crystal materials. All of nematic liquid crystal materials have low enough viscosity to apply conventional liquid crystal filling method to liquid crystal display panels. Small sized liquid crystal display panels such as 10-inch or less may have good enough throughput using conventional vacuum filling method described above. However, larger sized panels still have following technical issues with low viscous nematic liquid crystal materials.

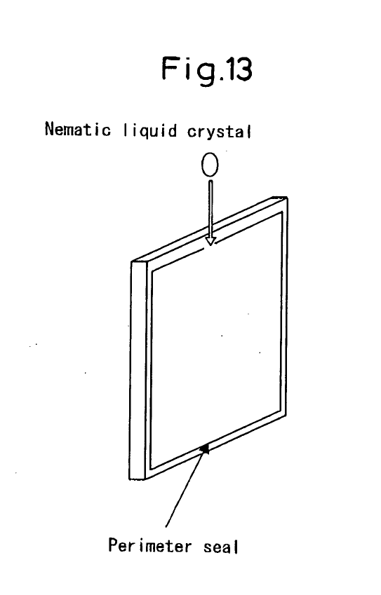

For mid to large sized nematic liquid crystal displays such as 10 to 50 inches sized panels, current vacuum filling and ODF filling methods require single sized panel for liquid crystal filling process as shown in FIG. 13. Due to fill hole requirement, the vacuum filling method needs to use single cut panel. OFD has to process both liquid crystal fill process and seal process at the same time, so that ODF treats single panel at one time. Therefore, regardless vacuum filling method, or ODF filling method, conventional filling methods require single panel treatment. Current volume manufacturing of liquid crystal display panels has a great benefit in its multiple panels treatment at the same time. For instance, lamination process of TFT substrate and color filter substrate is processed as multiple panels on each substrate. This process saves process time significantly, resulting in higher throughput in volume manufacturing. However, as described above here, current nematic based liquid crystal display manufacturing sacrifices this multiple panel system profit at its liquid crystal filling process.

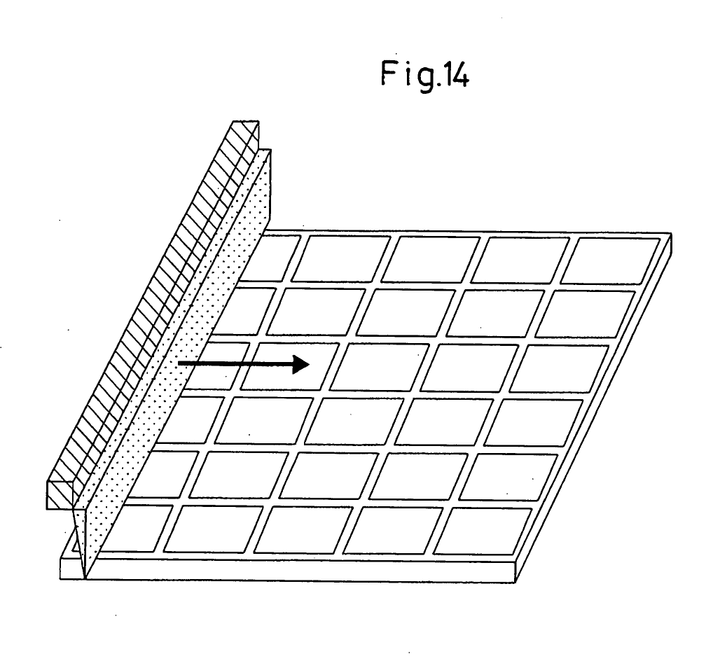

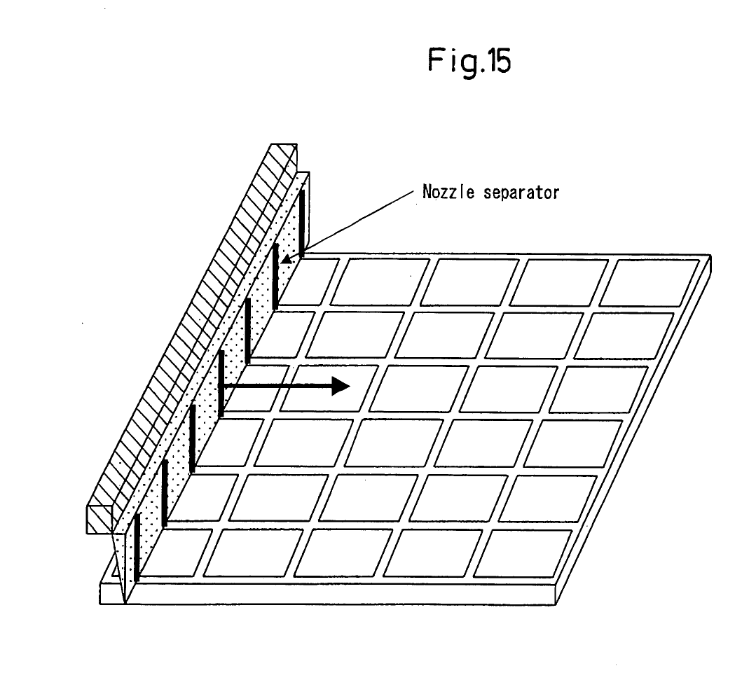

In order to keep the multiple panels process benefit at the liquid crystal filling process in nematic liquid crystal materials or low viscous liquid crystal materials, the Invention is slightly modified in its method. One of the most important points of the Invention is to use high viscous liquid crystal materials instead of low viscous liquid crystal materials. The necessary modification of the Invention to apply lower viscous nematic liquid crystal materials includes following two items. (1) To insert smectic liquid crystal phase(s) in the liquid crystal materials' phase sequence, (2) To add temperature decreasing function to the slit coating process. Actual method to apply the Invention to lower viscous nematic liquid crystal materials is following. All of current commercially acceptable nematic liquid crystal materials for liquid crystal display devices are consist of mixture of many single component of liquid crystal material. Some single component has smectic liquid crystal phase in its phase sequence. Some single component does not have smectic liquid crystal phase in its phase sequence. Some single component even does not have nematic liquid crystal phase in its phase sequence. Using these types of each single liquid crystal or non-liquid crystalline materials, a practical liquid crystal mixture for liquid crystal display devices is prepared. Important requirement for nematic liquid crystal mixture is to show wide enough temperature range of nematic liquid crystal phase as same as required electro-optic performance. Therefore, including high viscous smectic liquid crystal phase in a nematic phase liquid crystal mixture, the Invention is applicable to nematic liquid crystal mixture. In general, liquid crystal material shows several liquid crystal phases depending on temperature range regardless a single component or a mixture. A typical phase sequence is: Isotropic phase, Nematic phase, Smectic A phase, and Crystal. From free energy requirement, Smectic phase appears at lower temperature range than that of Nematic phase. Therefore, it is not difficult to include Smectic liquid crystal phase below nematic liquid crystal phase in terms of appearance temperature of each liquid crystal phase. As long as the nematic liquid crystal mixture has a smectic liquid crystal phase, the Invention is applicable with one more additional modification. The nematic liquid crystal mixture having smectic liquid crystal phase at lower temperature range from that of nematic phase, needs to be high viscous smectic liquid crystal phase to apply the Invention. Due to keeping high viscous smectic liquid crystal phase during its filling process for the Invention, it is required to keep low temperature to stabilize smectic liquid crystal phase. In order to keep low temperature, the slit coating process and panel lamination process are carried on at low temperature environment. This method enables multiple panel liquid crystal filling at the same time on the same TFT substrate and same color filter substrate as illustrated in FIG. 14. For this highly effective liquid crystal filling process, the nozzle of slit coating system has some barriers to avoid coating to gaps between neighbor panels on the multiple panels substrate as illustrated in FIG. 15. Unlike conventional liquid crystal filling methods for Nematic liquid crystal mixtures, the Invention with lower temperature smectic phase materials have the selective liquid crystal coating on the multiple panel single substrate. This multiple panel process provides much more manufacturing efficiency.

Hereinbelow, the present invention will be described in more detail with reference to specific Examples.

### EXAMPLES

### Example 1

### (The Present Invention)

Using non-sodium glass substrate having 300 mm×200 mm×0.7 mmt dimension, and 1000 Å of ITO transparent electrode with PI layer coating by spin coating and cured by clean oven, the smectic liquid crystal material was coated on the substrate using the custom made slit coating machine. The used smectic liquid crystal material was a home-made mixture. The main component of the smectic liquid crystal mixture is phenyl-pyrimidine core material. In order to confirm the thickness of coating layer, following method was taken. First of all, before the smectic liquid crystal material was coated on the substrate, the weight of 300 mm×200 mm×0.7 mmt ITO coated glass substrate with PI layer was measured. Actual weight of the glass was 92.4632 g. After the smectic liquid crystal was coated by the slit coating machine at the area of 260 mm×180 mm, the total weight of coated glass substrate was measured. Actual smectic liquid crystal coated area was also measured and it was same with designed area: 260 mm×180 mm. The measured total weight of the coated liquid crystal layer was 93.6 mg. Here, the weight of the liquid crystal material has following relationship with the coated area.

a×b×c×gl=W (2)

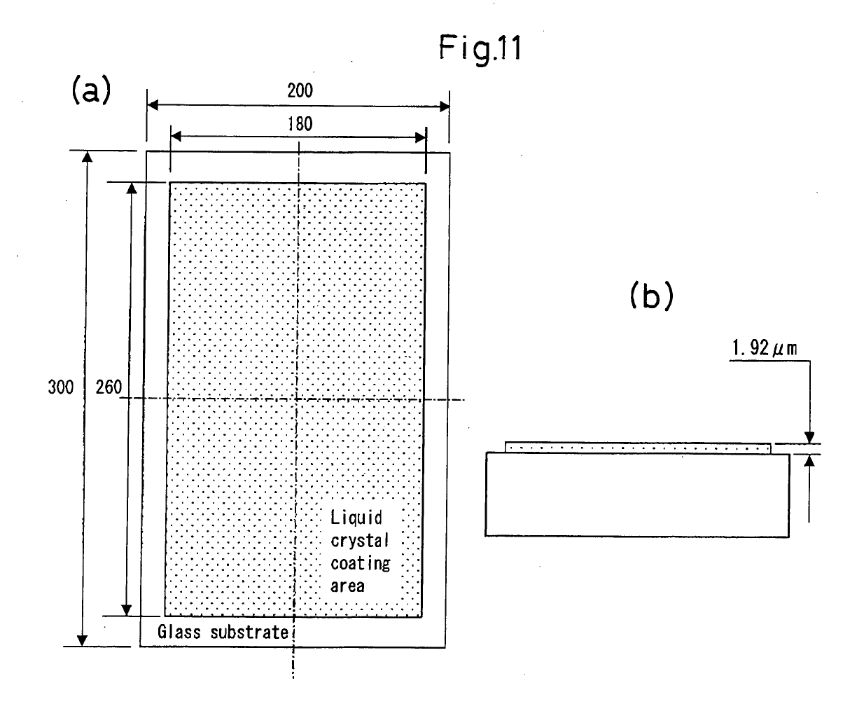

At the equation (2), a and b are horizontal and vertical sizes of the coated area. c is the layer thickness of the coating layer. gl is the specific weight of the smectic liquid crystal material, and W is the weight of the coated smectic layer. gl was measured by a floating measuring method. It was 1.04. Using those measured value to a, b, gl and W; c: that is average layer thickness was obtained as 1.92 micro meter as shown in FIG. 11.

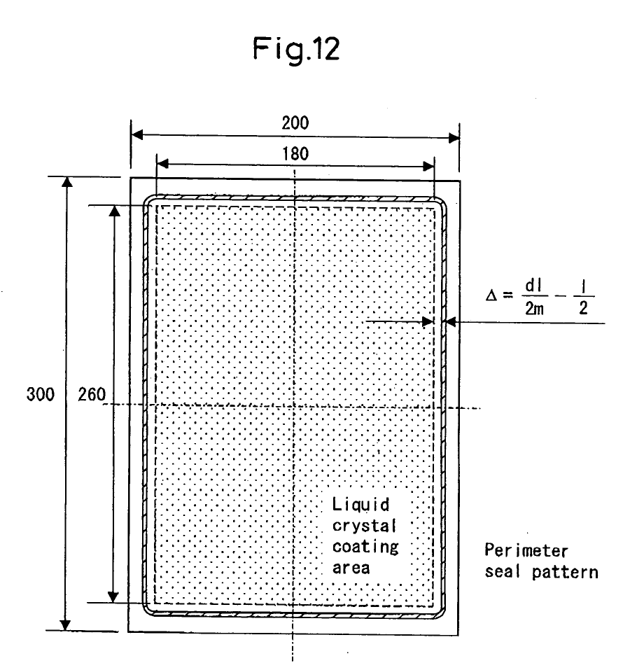

Using same size of glass substrate (300 mm×200 mm×0.7 mmt), average particle size of 1.9 micron meter spacer balls made of silicon dioxide were dispersed on the substrate. The spacer balls were dispersed by 30 particles per squire millimeter by wet dispersion method. After the spacer balls were dispersed by wet method, and dried at 80 degrees C., 30 minutes. On this substrate, perimeter seal pattern was dispensed using dispenser system made of Musashi Engineering (type: SHOTMASTER 300). The formed perimeter seal pattern was shown in FIG. 12. As shown in FIG. 12, the perimeter seal pattern was formed with its width of 1 mm and with Δ of 0.29 mm. This Δ value was decided according to equation (1).

This substrate with spacer balls and the substrate with liquid crystal material coated by slit coating system were set in the vacuum chamber. The vacuum level was kept at 15 mTorr, 30 minutes, at room temperature. Then, the spacer balls dispersed substrate and liquid crystal coated substrate were laminated in the vacuum chamber.

The obtained smectic liquid crystal panel did not show any bubble. Careful observation by polarized microscope at the interface area between perimeter seal and liquid crystal area did not show any lack of liquid crystal material. Uniformity of the panel gap was also concerned by the number of Newton Rings. The obtained liquid crystal panel did not show any Newton Rings, which means the panel gap unevenness is at most within 0.1 micro meter. More practical panel gap uniformity was measured by light throughput uniformity under the application of external voltage. Since, this panel has single electrode, when external applied voltage is applied to this panel, whole electrode area should have uniform light throughput under the premise of uniform panel gap. Light throughput of the 25 points of the panel was measured by using polarized microscope and photo-multiplier as photo-detector. These light throughputs were measured by applying 1 kHz, rectangular waveform with peak-to-peak of 5 V. Table 1 shows the result of light throughput at each measurement spot.

### [Table 1]

TABLE 1
Uniformity of light throughput used the Invention
Table 1

| | | | | |
|---|---|---|---|---|
| 235 | 236 | 236 | 236 | 236 |
| 236 | 236 | 236 | 236 | 237 |
| 235 | 235 | 235 | 236 | 237 |
| 236 | 236 | 236 | 236 | 236 |
| 236 | 238 | 237 | 237 | 237 |
| 237 | 238 | 238 | 237 | 237 |

Measurement Data were Light Throughput Measured by mV

Actual measured spot size was 2 mm diameter area at each measured spot. The measurement result showed less than 1.4% light throughput valuation all over the screen area. Table 1 clearly suggests this new room temperature liquid crystal filling method realized uniform enough panel gap without having any air bubble or lack of liquid crystal materials in the panel. Total process time of this liquid crystal filling was less than 20 minutes.

### Example 2

(The Present Invention)

Using non-sodium glass substrate having 300 mm×200 mm×0.7 mmt dimension, and 1000A of ITO transparent electrode with PI layer coating by spin coating and cured by clean oven, the smectic liquid crystal material was coated on the substrate using the custom made slit coating machine in FIG. 7(a). The used smectic liquid crystal material was a home-made mixture. The main component of the smectic liquid crystal mixture is phenyl-pyrimidine core material. In order to confirm the thickness of coating layer, following method was taken. First of all, before the smectic liquid crystal material was coated on the substrate, the weight of 300 mm×200 mm×0.7 mmt ITO coated glass substrate with PI layer was measured. Actual weight of the glass was 92.9841 g. Using this glass substrate, perimeter seal material was dispensed at the set designed area. The dispensed area was decided by the calculation of equation (1). Here, A was set as 0.29 mm, with dispensed seal width of 1 mm. After procured the dispensed perimeter seal, again, total weight of the glass substrate was measured. The weight then, was 95.5713 g. Then, the smectic liquid crystal was coated by the slit coating machine at the area of 260 mm×180 mm, the total weight of coated glass substrate was measured. Actual smectic liquid crystal coated area was also measured and it was same with designed area; 260 mm×180 mm. The measured total weight of the coated liquid crystal layer was 93.5 mg. Here, the weight of the liquid crystal material has following relationship with the coated area.

a×b×c×gl=W (2)

At the equation (2), a and b are horizontal and vertical sizes of the coated area. c is the layer thickness of the coating layer. gl is the specific weight of the smectic liquid crystal material, and W is the weight of the coated smectic layer. gl was measured by a floating measuring method. It was 1.04. Using those measured value to a, b, gl and W; c: that is average layer thickness was obtained as 1.92 micro meter.

Using same size of glass substrate (300 mm×200 mm×0.7 mmt), average particle size of 1.9 micron meter spacer balls made of silicon dioxide were dispersed on the substrate. The spacer balls were dispersed by 30 particles per squire millimeter by wet dispersion method. After the spacer balls were dispersed by wet method, and dried at 80 degrees C., 30 minutes. This substrate with spacer balls and the substrate with liquid crystal material coated by slit coating system were set in the vacuum chamber. The vacuum level was kept at 15 mTorr, 30 minutes, at room temperature. Then, the spacer balls dispersed substrate and liquid crystal coated substrate were laminated in the vacuum chamber. The obtained smectic liquid crystal panel did not show any bubble. Careful observation by polarized microscope at the interface area between perimeter seal and liquid crystal area did not show any lack of liquid crystal material. Uniformity of the panel gap was also concerned by the number of Newton Rings. The obtained liquid crystal panel did not show any Newton Rings, which means the panel gap unevenness is at most within 0.1 micro meter. More practical panel gap uniformity was measured by light throughput uniformity under the application of external voltage. Since, this panel has single electrode, when external applied voltage is applied to this panel, whole electrode area should have uniform light throughput under the premise of uniform panel gap. Light throughput of the 25 points of the panel was measured by using polarized microscope and photo-multiplier as photo-detector. These light throughputs were measured by applying 1 kHz, rectangular waveform with peak-to-peak of 5 V. Table 2 shows the result of light throughput at each measurement spot.

### [Table 2]

TABLE 2
Uniformity of light throughput used other type of the Invention
Table 2

| | | | | |
|---|---|---|---|---|
| 237 | 237 | 238 | 236 | 236 |
| 237 | 237 | 238 | 236 | 238 |
| 237 | 236 | 236 | 235 | 237 |
| 236 | 236 | 235 | 235 | 236 |
| 236 | 237 | 236 | 236 | 237 |
| 237 | 237 | 236 | 236 | 237 |

Measurement Data were Light Throughput Measured by mV

Actual measured spot size was 2 mm diameter area at each measured spot. The measurement result showed less than 1.4% light throughput valuation all over the screen area. Table 2 clearly suggests this new room temperature liquid crystal filling method realized uniform enough panel gap without having any air bubble or lack of liquid crystal materials in the panel. Total process time of this liquid crystal filling was less than 20 minutes.

### Example 3

(Control)

Using a pair of non-sodium glass substrate having 300 mm×200 mm×0.7 mmt dimension, and 1000 Å of ITO transparent electrode with PI layer coating by spin coating and cured by clean oven, a vacant panel was laminated. At this lamination, average particle size of 1.9 micro meters of silicon oxide particles were used as spacers. These spacer balls were dispersed on the one substrate by wet dispersed method. After dried at 80 degrees C., 30 minutes, the panel lamination was carried on. Used perimeter seal was thermoset glue. This seal material was dispensed on the other substrate. After pre curing, lamination was done.

This laminated vacant panel was set in the vacuum chamber. This vacuum chamber is equipped with thermal heater with precision temperature control system. After the vacant panel was set ion the heater in the vacuum chamber, the chamber was kept 15 mTorr at 100 degrees C., 1 hour. After the vacuum condition, smectic liquid crystal material was dispensed near the fill hole of the panel. Right after the smectic liquid crystal material was dispensed on the panel, the liquid crystal was elevated to isotropic phase, them, it went into the panel. Keeping the vacuum and elevated temperature condition 30 minutes, after confirmed filled with whole panel area, the chamber was started to put into dried nitrogen purging. Then, the temperature of the panel was decreased 1 degree C. per minute rate till the temperature came down to 35 degrees C. Total above process took 175 minutes including preparation time between each process at this liquid crystal fill.

The obtained smectic liquid crystal panel did not show any bubble. Careful observation by polarized microscope at the interface area between perimeter seal and liquid crystal area showed very tiny lack of liquid crystal area just at interface area of liquid crystal area and perimeter seal area. Uniformity of the panel gap was also concerned by the number of Newton Rings. The obtained liquid crystal panel showed two Newton Rings, which means the panel gap unevenness is at most within 0.6 micro meter. More practical panel gap uniformity was measured by light throughput uniformity under the application of external voltage. Since, this panel has single electrode, when external applied voltage is applied to this panel, whole electrode area should have uniform light throughput under the premise of uniform panel gap. Light throughput of the 25 points of the panel was measured by using polarized microscope and photo-multiplier as photo-detector. These light throughputs were measured by applying 1 kHz, rectangular waveform with peak-to-peak of 5 V. Table 3 shows the result of light throughput at each measurement spot.

### [Table 3]

TABLE 3
Uniformity of light throughput used conventional filling method
Table 3

| | | | | |
|---|---|---|---|---|
| 230 | 232 | 233 | 232 | 234 |
| 230 | 234 | 235 | 236 | 237 |
| 228 | 233 | 236 | 236 | 234 |
| 227 | 236 | 235 | 235 | 230 |
| 227 | 238 | 236 | 236 | 234 |
| 226 | 240 | 239 | 237 | 236 |

Measurement Data were Light Throughput Measured by mV

Actual measured spot size was 2 mm diameter area at each measured spot. The measurement result showed 5.3% of light throughput valuation all over the screen area. Table 3 clearly suggests this conventional liquid crystal filling method is clearly inferior to newly invented method both in terms of panel gap uniformity and process time.

### Effect of the Invention

The present invention realizes effective filling of viscous Smectic liquid crystal which has been impossible to fill at room temperature. The precise control of liquid crystal layer thickness by a slit coating system enables liquid crystal filling at room temperature and at atmosphere. A room temperature and at atmosphere liquid crystal filling realizes extremely effective liquid crystal fill in very viscous liquid crystal materials such as smectic liquid crystal materials. Without elevating temperature in order to reduce viscosity of the liquid crystal material, there is no need to reduce temperature taking long time under the precise temperature control. This enables extremely high efficient liquid crystal filling process in terms of throughput of the process. Moreover, room temperature and at atmosphere liquid crystal filling provides much wider selection of applicable perimeter seal materials due to free from precise CTE matching with that of viscous liquid crystal materials.

In conclusion, the Invention realizes high volume production of Smectic liquid crystal display devices which have been though to be impossible for volume production without any significant investment for filling equipment as well as giving wide selection of applicable perimeter seal materials.

What is claimed is:

1. A liquid crystal filling system comprising:
a slit coating system, and
a controller for precisely controlling the thickness of a liquid crystal layer provided by the slit coating system.

2. A liquid crystal filling system according to claim 1, wherein the slit coating system works under room temperature.

3. A liquid crystal filling system according to claim 1, wherein the slit coating system works under the atmosphere.

4. A liquid crystal filling system according to claim 1, wherein the system is used with a specific designed perimeter seal pattern designated following: The perimeter seal pattern and coated liquid crystal layer have specific relationship in terms of their relative positioning: the relative positioning is defined as
Δ=(dl/2m)−(l/2)
Here, Δ is the gap between the edge of perimeter seal pattern as layered, and the edge of the coated liquid crystal area. d is height of the perimeter seal pattern as layered, l is width of the perimeter seal pattern as layered, m is the panel gap after lamination.

5. A liquid crystal filling system according to claim 4, wherein the substrate used for lamination of the liquid crystal panel is formed both a liquid crystal coating layer and perimeter seal pattern on the same substrate.

6. A liquid crystal filling system according to claim 4, wherein the designed perimeter seal pattern is first formed by a dispensed method, a printing method, a stamping method, or taping method, then, a slit coating liquid crystal layer is formed.

7. A liquid crystal filling system according to claim 4, wherein the slit coating liquid crystal layer is first formed, then the designed perimeter seal pattern is first formed by a dispensed method, a printing method, a stamping method, or taping method.

8. A liquid crystal filling system according to claim 4, wherein the designed perimeter seal patter has at least one open area.

9. A liquid crystal filling system according to claim 8, wherein excess amount of coated liquid crystal materials is pushed out from the open areas of designed perimeter seal pattern, then the pushed out liquid crystal material is wiped out, and the open areas are sealed by seal material.

10. A liquid crystal filling system comprising:
a slit coating system, and
a controller for precisely controlling the thickness of a liquid crystal layer provided by the slit coating system,
wherein the slit coating system is capable of **having smectic liquid crystal phase for nematic liquid crystal mixture** to enable the slit coating of the nematic liquid crystal mixture.

11. A liquid crystal filling process according to claim 10, wherein the slit coating system works under cooled temperature showing smectic liquid crystal phase.

12. A liquid crystal filling process according to claim 10, wherein the slit coating system has s temperature cooling down system.

13. A liquid crystal display device, comprising:
a pair of substrates, and
a liquid crystal layer disposed between the pair of substrates,
wherein the liquid crystal layer has been formed by slit coating.

14. A liquid crystal display device according to claim 13, wherein the liquid crystal layer is surrounded by a sealing material disposed between the pair of substrates.
